(19) United States
(12) Patent Application Publication
(10) Pub. No.: US 2008/0106432 A1
(43) Pub. Date: May 8, 2008

(54) Universal remoter controller having function of preventing device code from releasing by mistake operation

(76) Inventor: Jung-Hua Lai, Taipei Hsien (TW)

Correspondence Address: JUNG-HUA LAI, 235 Chung-Ho, Box 8-24, Taipei, omitted

(21) Appl. No.: 11/586,701

(22) Filed: Oct. 26, 2006

(51) Int. Cl. G05B 19/02

(52) U.S. Cl. 340/825.22; 341/176; 340/825.72

(57) ABSTRACT

A universal remoter controller has a function of preventing device code from releasing by mistake operations. The universal remoter controller comprises a central processing unit having a main memory, and a second memory; the main memory in the central processing unit selected from one of a static random accessing memory, a dynamic random accessing memory or a flash memory; the main memory having frequencies of various electronic devices; a sub-memory being located in or connected to the central processing unit for recording the device codes and device names corresponding to the codes; and a key set connected to the central processing unit; the key set including at least one class key, one locking key, and one releasing key.

### FIELD OF THE INVENTION

The present invention relates to remoter controller, and particularly to a universal remoter controller having a function of preventing device code from releasing by mistake operation, wherein when it is desired to lock a device code of an electronic device, the class key is pressed for a predetermined time period from 0.1 second to 5 seconds, and then the central processing unit connects the device code through the recoding data in the main memory and second memory; and the device code is locked without releasing or clearing by pressing other keys; if it desired to unlock the device code, the class key is pressed and the releasing key is pressed through a predetermined period from 0.1 second to 5 seconds and then the state is released.

### BACKGROUND OF THE INVENTION

A new remote controller must record a device to be used so that the remote controller can be used to control the device.

The code of the device is recorded in the memory of the remoter controller. However, the setting can be reset by pressing a set key. However, in updating a battery of the remote controller, the code of the device possibly disappears, or if the remoter controller falls to the ground, it is possible that the code is released, but it is difficult for a child or an old man to reset the remote controller.

### SUMMARY OF THE INVENTION

Accordingly, the primary object of the present invention is to provide a universal remoter controller, which has a function of preventing device code from releasing by mistake operation from old men and children. Thereby even in updating the battery of the remote controllers, the device will not disappear.

To achieve above objects, the present invention provides a universal remoter controller having a function of preventing device code from releasing by mistake operation. The universal remoter controller comprises a central processing unit having a main memory, and a second memory; the main memory in the central processing unit selected from one of static random accessing memory, a dynamic random accessing memory or a flash memory; the main memory having frequencies of various electronic devices; a sub-memory being located in or connected to the central processing unit for recording the device codes and device names corresponding to the codes; and a key set connected to the central processing unit; the key set including at least one class key, one locking key, and one releasing key.

The various objects and advantages of the present invention will; be more readily understood from the following detailed description when read in conjunction with the appended drawing.

### BRIEF DESCRIPTION OF THE DRAWINGS

FIG. 1 is a schematic view of the first embodiment of the universal remoter controller of the present invention.

FIG. 2 is a schematic view of the second embodiment of the universal remoter controller of the present invention.

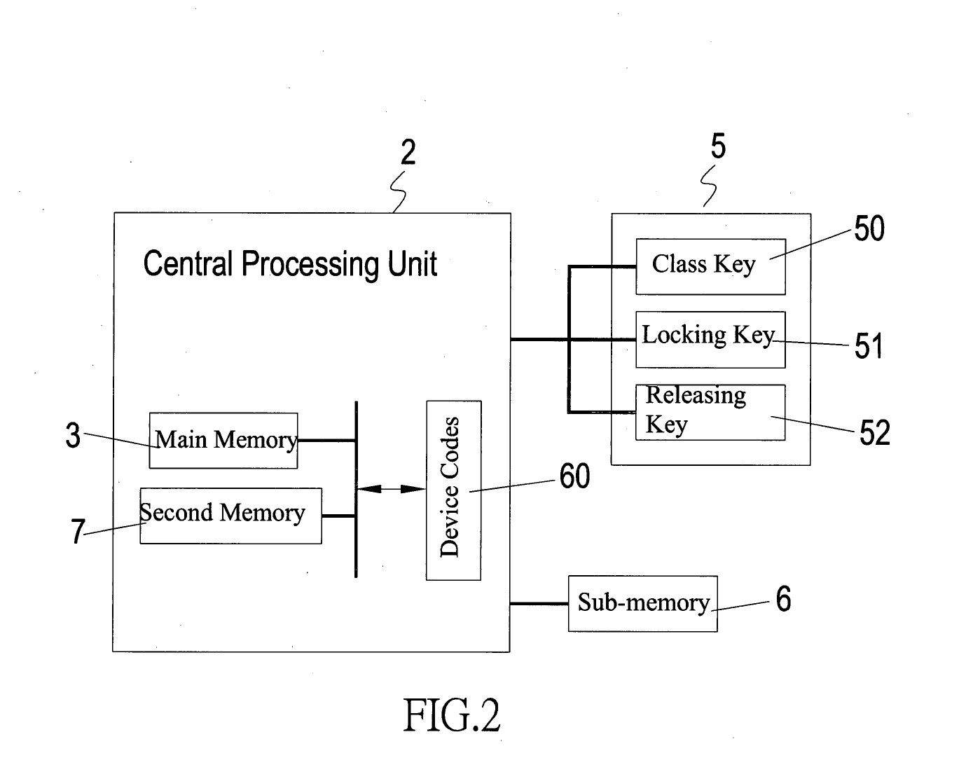

FIG. 3 shows a flow diagram in the first operation of the present invention.

FIG. 4 shows a flow diagram in the second operation of the present invention.

### DETAILED DESCRIPTION OF THE INVENTION

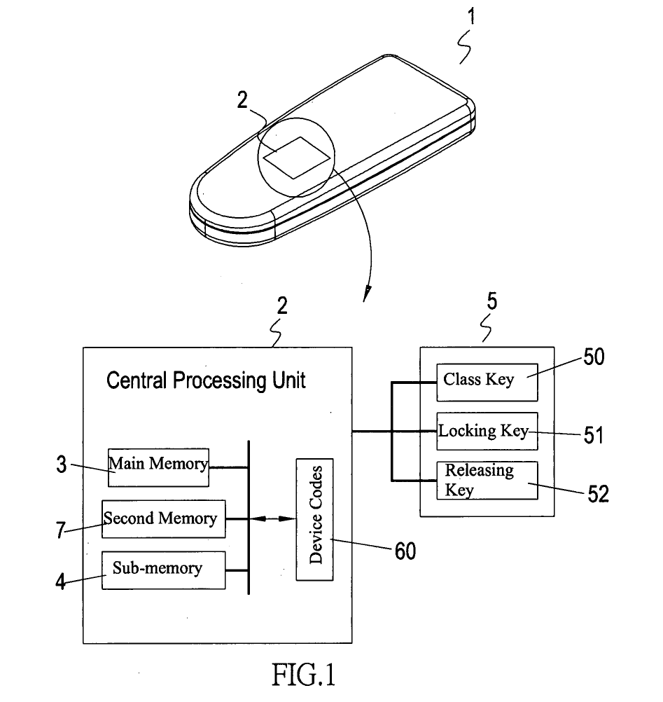

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIG. 1, the universal remoter controller 1 of the present invention is illustrated. The present invention has the following elements.

A central processing unit 2 has a main memory 3, a sub-memory 4 and a second memory 7.

The main memory 3 in the central processing unit 2 is selected from one of a static random accessing memory, a dynamic random accessing memory and a flash memory. The main memory 3 recodes frequencies of various electronic devices.

The sub-memory 4 in the central processing unit 2 serves for recording the device codes 60 and device names corresponding to the device codes 60.

A key set 5 is connected to the central processing unit 2. The key set 5 includes at least one class key 50, one locking key 51, and one releasing key 52.

Referring to FIG. 6, the second embodiment of the present invention is illustrated. In this embodiment, the present invention includes the following elements.

A central processing unit 2 has a main memory 3. The main memory 3 in the central processing unit 2 is selected from one of static random accessing memory, a dynamic random accessing memory or a flash memory. The main memory 3 has frequencies of various electronic devices.

A sub-memory 6 is connected to the central processing unit 2 for recording the device codes 60 and device names corresponding to the codes 60.

A key set 5 is connected to the central processing unit 2. The key set 5 includes at least one class key 50, one locking key 51, and one releasing key 52.

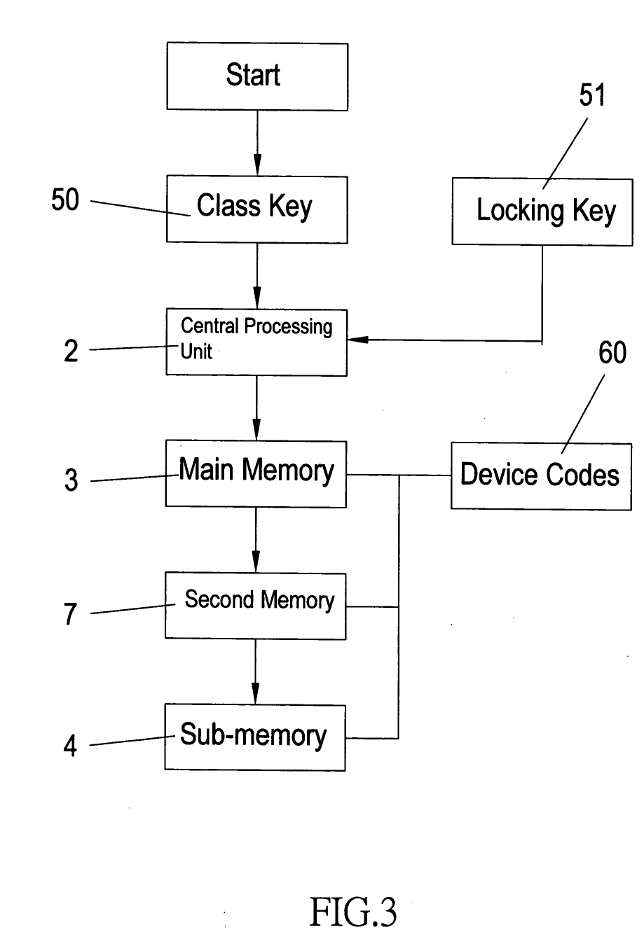

Referring to FIG. 3, in operation, the class key 50 is pressed without releasing and then the locking key 51 is pressed through a predetermined timer, such as 0.1 second to 5 second. Then the main memory 3 and second memory 7 in the central processing unit 2 will record the device code 60 of an electronic device. Then the device code is locked by the remote controller, i.e., the remoter controller is used to remotely control the device. At this time, if other key is pressed, the state cannot be switched or clear so as to have the effect of preventing the set device code from releasing, i.e, the remoter controller can not control the device with the device code.

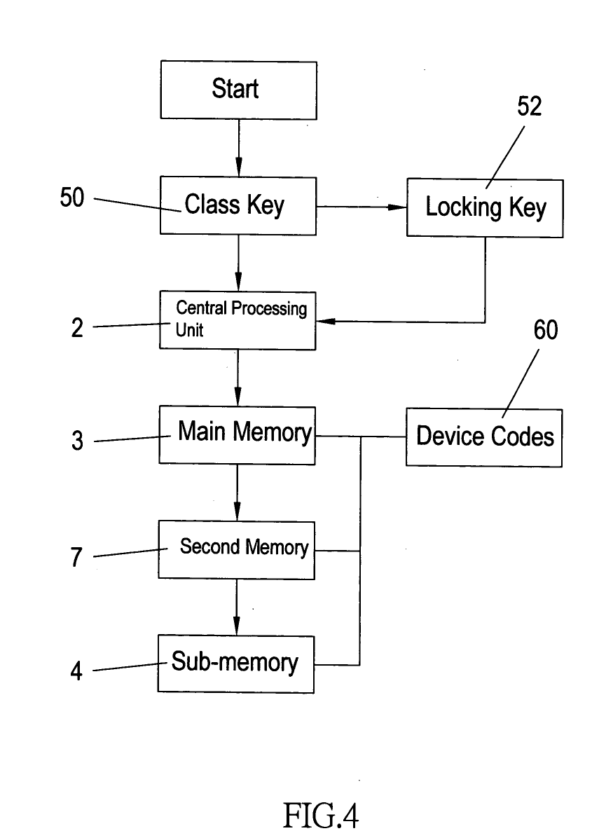

Referring to FIG. 4, if it is desired to release the state, the class key 50 is pressed, and then the releasing key 52 is pressed through a predetermined time period, the state is released. Then the state can be switched to other electronic device. If it is desired to lock an encrypted code, above mentioned operations are repeated again. Thus the codes of the device can not be released by mistake operations.

Advantages of the present invention are that the codes of the devices are not released due to mistake of pressing the keys. The key can be locked without released.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A universal remoter controller having a function of preventing device code from releasing by mistake operations, the universal remoter controller comprising:
a central processing unit having a main memory, a sub-memory and a second memory;
the main memory in the central processing unit selected from one of a static random accessing memory, a dynamic random accessing memory and a flash memory; the main memory having frequencies of various electronic devices;
the sub-memory in the central processing unit for recording the device codes and device names corresponding to the codes; and
a key set connected to the central processing unit; the key set including at least one class key, one locking key, and one releasing key;
wherein when it is desired to lock a device code of an electronic device, the class key is pressed for a predetermined time period from 0.1 second to 5 seconds, and then the central processing unit connects the device code through the recoding data in the main memory and second memory; and the device code is locked without releasing or clearing by pressing other keys so that the remoter controller can control the electronid device; if it desired to unlock the device code, the class key is pressed and the releasing key is pressed through a predetermined period from 0.1 second to 5 seconds and then the state is released.

2. A universal remoter controller having a function of preventing device code from releasing by mistake operations, the universal remoter controller comprising:
a central processing unit having a main memory, and a second memory;
the main memory in the central processing unit selected from one of a static random accessing memory, a dynamic random accessing memory and a flash memory; the main memory having frequencies of various electronic devices;
a sub-memory connected to the central processing unit for recording the device codes and device names corresponding to the codes; and
a key set connected to the central processing unit; the key set including at least one class key, one locking key, and one releasing key;
wherein when it is desired to lock a device code of an electronic device, the class key is pressed for a predetermined time period ranged from 0.1 second to 5 seconds, and then the central processing unit connects the device code through the recoding data in the main memory and second memory; and the device code is locked without releasing or clearing by pressing other keys so that the remoter controller can control the electronid device; if it desired to unlock the device code, the class key is pressed and the releasing key is pressed through a predetermined period from 0.1 second to 5 seconds and then the state is released.
